(19) United States
(12) Patent Application Publication
(10) Pub. No.: US 2002/0010093 A1
(43) Pub. Date: Jan. 24, 2002

(54) Active charcoal improved by treatment with acid and its use in separating gases

(75) Inventors: Christian Monereau, Paris (FR); Serge Moreau, Velizy Villacoublay (FR)

Correspondence Address: YOUNG & THOMPSON, 745 SOUTH 23RD STREET 2ND FLOOR, ARLINGTON, VA, 22202

(73) Assignee: L'AIR LIQUIDE SOCIETE ANONYME POUR L'ETUDE ET L'EXPLOITATION DES PROCEDES GEORGES CLAUDE

(21) Appl. No.: 09/799,736

(22) Filed: Mar. 7, 2001

(30) Foreign Application Priority Data
Mar. 7, 2000 (FR) 0002925

(51) Int. Cl. B01D 53/48; C01B 31/08

(52) U.S. Cl. 502/416; 423/461; 423/460; 502/418; 423/244.01; 95/135; 95/136

(57) ABSTRACT

The invention relates to a process for the manufacture of improved active charcoal exhibiting a high resistance to sulphur-comprising products, such as H₂S, COS and mercaptans; to the improved active charcoal thus obtained; and to a process for the purification of a gas stream comprising sulphur-comprising compounds. The gas to be treated is air, nitrogen, hydrogen produced by reforming or cracking of alcohols, of ammonia or of hydrocarbons, natural gas, combustion gas or fermentation gas.

The present invention relates to the field of the purification of gases or gas mixtures by adsorption of the sulphur-comprising impurities which are present therein on a carbonaceous adsorbent of active charcoal type, in particular a PSA process for purifying a gas, such as hydrogen, comprising sulphur-comprising impurities, such as the compounds H₂S, COS and mercaptans; to an improved active charcoal which is particularly well suited to gas purification or separation and to a chemical treatment process which makes it possible to manufacture such an improved active charcoal.

A PSA (Pressure Swing Adsorption) unit for the purification of gases usually comprises an adsorbent or a combination of adsorbents which has to be capable of selectively retaining the impurities present in the gas to be treated.

PSA processes and units have proved to be very efficient in the separation of varied gas mixtures, in particular for obtaining oxygen or nitrogen from air and for the production of pure hydrogen from gas mixtures contaminated by various impurities.

Now, the production of hydrogen of high purity is of great advantage industrially, high purity hydrogen being widely used in numerous synthetic processes, such as hydrocracking, the production of methanol, the production of oxoalcohols and isomerization processes.

In general, PSA processes take advantage of the adsorption selectivity of a given adsorbent for one or more of the contaminants in the gas mixture to be purified.

Thus, in the case of the purification of hydrogen, the impurities which usually have to be removed are: water vapour, CO₂, CO, nitrogen, saturated or unsaturated and linear, branched or cyclic hydrocarbons comprising one or more carbon atoms in their hydrocarbonaceous structure and their derivatives, for example C₁-C₈ compounds, such as CH₄, C₂H₄, C₂H₆, C₃H₈ or BTX (benzene-toluene-xylene) compounds; mercaptans; chlorine or ammonia, COS; H₂S; SO₂; alcohols, for example light C₁-C₃ alcohols; or other volatile organic compounds, such as esters, ethers, acids and halogenated compounds.

These compounds are generally removed by an array of adsorbents, that is to say of adsorbent layers placed in series. Thus, use is conventionally made of alumina or of silica gel for retaining, in particular, water vapour; of active charcoal for retaining, in particular, hydrocarbons, CO₂ and water vapour; and of zeolite for removing the impurities which do not adsorb to any great extent, such as CO and nitrogen.

Usually, the adsorbents are placed in a single adsorber but more usually in several adsorbers operating in alternation.

The proportions of the various adsorbents within the adsorbent bed depend on the composition of the gas to be treated and on the pressure and therefore the number of possible combinations of adsorbents is large.

The impurities are removed by one or more adsorbents placed in series from the upstream end of the adsorber, that is to say the side where the gases to be treated enter the said adsorber.

Thus, mention may be made of the document WO-A-97/45363 which relates to a process for the purification of hydrogen-based gas mixtures polluted by various impurities, including carbon monoxide and at least one other impurity chosen from carbon dioxide and saturated or unsaturated and linear, branched or cyclic C₁-C₈ hydrocarbons. The gas stream to be purified is brought into contact, in an adsorption zone, with a first adsorbent selective with respect to carbon dioxide and to C₁-C₈ hydrocarbons and a second adsorbent which is a zeolite of the faujasite type, the zeolite being exchanged to at least 80% with lithium and having an Si/Al ratio of less than 1.5, for removing at least the carbon monoxide (CO). According to this document, the improvement introduced by the process is due to the use of a particularly effective zeolite, namely a zeolite X exchanged with lithium.

The document U.S. Pat. No. 3,150,942 for its part teaches the use of a zeolite comprising sodium cations or sodium and calcium cations for purifying a hydrogen stream.

Similarly, the document U.S. Pat. No. 4,477,267 discloses a process for the purification of hydrogen employing a zeolite X which is exchanged to from 70 to 90% with calcium cations and which additionally comprises an inert binder.

The document U.S. Pat. No. 4,957,514 discloses a process for the purification of hydrogen employing a zeolite X exchanged to from 60 to 80% with barium cations.

In addition, the document U.S. Pat. No. 5,489,327 relates to the purification of hydrogen gas by bringing into contact with a zirconium alloy hydride.

Finally, the document JP-A-860146024 discloses a PSA process for purifying impure gases using a mordenite-type zeolite exchanged with lithium, on the production side, and another zeolite, on the feed side.

Conversely, some documents emphasize that the adsorbent or the adsorbents employed in a PSA process for purifying hydrogen are only of slight importance, indeed even of no importance.

Thus, the document “Pressure Swing Adsorption”, 1994, VCH publishers, D. M. Ruthvens, S. Farooq and K. S. Knaebel, page 238, teaches that “since the selectivity for most of the impurities is high in comparison with that for hydrogen, any adsorbent can be used” for purifying hydrogen.

Similarly, from the document U.S. Pat. No. 4,299,596, any conventional adsorbent can be used to produce hydrogen, for example active charcoals, silica gels, molecular sieves, such as zeolites, carbon screens, and the like.

Furthermore, the document U.S. Pat. No. 4,482,361 mentions the possibility of indiscriminately using appropriate adsorbents, such as zeolitic molecular sieves, active charcoals, silica gels, activated aluminas or similar materials.

The document U.S. Pat. No. 4,834,780 similarly teaches that the adsorption can be carried out in all cases where the selection has been made of an adsorbent which is suitable for the separation process under consideration, for example active charcoals, silica gels, aluminas or molecular sieves.

More generally, varied gas sources are treated by industrial-scale adsorption.

Mention may be made, by way of example, of natural gas, synthesis gases, various chemical or petrochemical waste gases or waste gases from the oil industry, combustion gases, gases resulting from waste treatment, and the like.

A large number of these gas mixtures comprise sulphur-comprising products very often present originally in the starting material, such as coal, hydrocarbon deposits or natural CO₂ sources, or indeed even added during upstream treatments, for example to give the gas a smell by addition of mercaptans, or as reactant or reaction intermediate; consequently, varied adsorption processes are used on such gases.

The adsorbent can be used in the process in various ways. Thus, it may relate to purification with a lost charge and a lost adsorbent, that is to say that, once the adsorbent is saturated with the compound which it is desired to retain, the said adsorbent charge is replaced with a fresh charge.

Conversely, it may relate to cyclic purifications in which phases of adsorption and of regeneration alternate, such as TSA processes, which essentially use a rise in temperature to regenerate the saturated adsorbent, or PSA processes, which use for the same purpose essentially the effect of a fall in the pressure optionally ranging as far as placing under vacuum, as explained above.

There also exists mixed processes which employ several types of operation simultaneously.

The adsorbents used are varied and mention may conventionally be made of silica gels, activated aluminas, zeolites or active charcoals.

In the case of the purification of fluids polluted by sulphur-comprising products, active charcoals are very widely used, in particular because of the accessibility of their large pore volume.

As regards, for example, stopping hydrogen sulphide (H₂S), it should be noted that the active charcoal sold by Norit under the reference RB 3 is recommended for the purification of sewer gas, whereas that reference R 1 Extra is recommended for gas masks.

For the production of hydrogen, the Inventors have been led to study the treatment of various waste gases comprising sulphur-comprising products for the purpose of the creation of several PSA units for the treatment of gases from coke ovens.

Usually, an H₂ PSA unit employs, within each adsorber, a pressure cycle schematically comprising:

a substantially isobaric production phase at the high pressure of the adsorption cycle,

a phase of regeneration of the adsorbent comprising at least one stage of cocurrent decompression by pressure equalization with another adsorber; a final countercurrent depressurization stage with discharge of waste gas; and generally an elution stage at the low pressure of the cycle, the eluting gas originating from at least one second stage of cocurrent decompression of an adsorber; and

a repressurization phase comprising at least one stage of pressure equalization with another adsorber and a final recompression stage by means of production gas.

The cycles can generally comprise several, total or partial, equalization stages, preferably from 1 to 4 equalization stages.

The gas transfers can be carried out directly from adsorber to adsorber or via one or more gas storage tanks.

The stages of recompression by equalization and of recompression by the production gas may or may not be at least partially simultaneous and may optionally comprise a partial repressurization by feeding in gas.

Additional flushing stages may be introduced, in particular if it is desired to recover, for enhancement in value, another fraction of the gas to be treated other than hydrogen.

Furthermore, the cycle can also comprise standby times during which the adsorbers are isolated.

Conventionally, the adsorption pressure is between 5 bar and 70 bar, preferably between 15 bar and 40 bar; the desorption pressure is between 0.1 bar and 10 bar, preferably between 1 and 5 bar; and the temperature of the hydrogen stream to be purified is between −25° C. and +60° C., preferably between +5° C. and +35° C.

Furthermore, this is illustrated, for example, by the documents U.S. Pat. Nos. 3,702,525, 3,986,849, 4,077,779, 4,153,428, 4,696,680, 4,813,980, 4,963,339, 3,430,418, 5,096,470, 5,133,785, 5,234,472, 5,354,346, 5,294,247 and 5,505,764, which disclose operating cycles of PSA processes for producing hydrogen.

Such PSA units are employed on gases resulting from coke ovens, after these gases have been subjected to various treatments, such as washing operations carried out with water and/or with oil intended to retain a portion of the heaviest hydrocarbons, a partial desulphurization, and the like.

These coke oven gases, in addition to the main constituents, which are hydrogen, methane, carbon monoxide, hydrocarbons, carbon dioxide and nitrogen, include a large number of impurities, such as oxygen, sulphur-comprising products, very heavy hydrocarbons (≧C₇), tars, and the like.

Because of the presence of these tars, which can end up partially blocking the pores of the adsorbents, the adsorbers used on this type of gas often exhibit two distinctive features, namely:

each adsorber comprises a system of sloping internal grids allowing the adsorbent between these grids to be emptied and to be replaced by a fresh adsorbent without having to empty the whole of the adsorber. The volume which it is thus possible to change periodically can represent from 5 to 40% of the total volume of the adsorber, generally between 10 and 15%. The purpose of this system is to replace the adsorbent which has lost a portion of its adsorption capacity because of the impurities which are the most difficult to regenerate, restoring the full adsorption capacities to the adsorber and preventing these impurities from reaching the upper layers of the adsorbent bed.

each adsorber comprises, in particular in its lower part, systems for the withdrawal of adsorbents. Thus, by regularly analysing the said withdrawn adsorbents, it is possible to monitor the change in the impurities which are very difficult to regenerate and to measure the residual adsorption capacity of the adsorbent. This monitoring makes it possible to change the adsorbent at the appropriate moment.

The adsorbent used in the periodically replaceable zone is usually active charcoal available commercially from specialist companies, such as Norit, Ceca, Carbotech, Pica, and the like.

The first withdrawals carried out on industrial PSA units for the treatment of coke gas brought to light two phenomena.

Firstly, the presence of tars in the active charcoal but in relatively small amounts. The advance of these deposits over time was very slow and only the very first adsorbent layers were affected.

More significantly, sulphur deposits were observed, which deposits advance more rapidly towards the upper adsorbent layers.

When these sulphur deposits became significant, the adsorption capacity of the active charcoal decreased very sharply to reach, for example with respect to CO₂, only 50% of the original capacity.

It is immediately understood from this that, while a gradual loading of active charcoal by the tars is not worrying as it is very slow and very localized, the loading of the charcoal by sulphur-comprising deposits is conversely much more problematic as it advances more rapidly through the adsorbent and results, in addition, in a significant deterioration in the adsorption properties of the adsorbent, resulting in a fall in the efficiency of the gas separation process if the operation is carried out without a replacement zone or in a shorter loading period if the operation is carried out with a replacement zone.

It is known that the presence of sulphur-comprising products in the gases to be purified can present adsorption problems. In particular, during the dehydration of gases, such as natural gas, which comprise H₂S and CO₂, a problem can arise of the formation of COS according to the reaction:

H₂S+CO₂⇄COS+H₂O

This reaction can be catalysed by the zeolites, indeed even by the inorganic binders involved in the shaping of the said zeolites. As COS is weakly adsorbed, the result is a premature breakthrough of this product into the purified gas.

In this case, zeolite 5A is believed to have a weaker catalytic activity than zeolite 4A or zeolites of the X type.

The document U.S. Pat. No. 4,329,160 recommends the use of certain specific molecular sieves in overcoming the formation of COS.

Another problem is the significant reduction in the lifetime of the molecular sieves brought about by sulphur deposits in the simultaneous presence of an oxidizing compound, such as traces of oxygen, or by coke deposits, in particular in the case of mercaptans, as is emphasized in the document U.S. Pat. No. 3,849,299, which relates to the suppression of coke deposits in an adsorbent of 5A type after treatment with hydrogen.

The removal of H₂S (and of SO₂) in a gas flow by addition of oxygen and passing the mixture over active charcoal with deposition of sulphur is also disclosed by the document U.S. Pat. No. 4,263,271. However, the question of the impact of impurities of metal oxide type in the active charcoal was not tackled in this document. The document U.S. Pat. No. 5,256,384 is analogous to U.S. Pat. No. 4,263,271.

Furthermore, the document U.S. Pat. No. 5,976,373 relates to the purification from H₂S of biogas resulting from anaerobic digesters. The stopping of H₂S is also carried out with deposition of sulphur in the presence of an addition of oxygen, namely air.

It is found that, in the prior art, the tendency is instead to promote depositions of sulphur on the charcoal, which conflicts with the aim desired in the context of the present invention.

Furthermore, the document U.S. Pat. No. 5,695,483 provides a process for the chemical activation of active charcoal in which the charcoal is brought into contact with a basic potassium hydroxide solution. The charcoal, thus activated, can be used to fractionate hydrocarbons, to purify industrial gases, in pollution control devices, in water treatment, as catalyst, and the like.

The document U.S. Pat. No. 4,157,314 teaches a process for the manufacture of abrasion-resistant active charcoal particles by bringing the charcoal into contact with a dilute acid solution at a concentration of 1 to 25% by weight, so as to reduce the volatile content and to increase the non-volatile content of the charcoal.

In addition, the document U.S. Pat. No. 5,013,698 discloses a process for the regeneration of spent active charcoal which has been used for water purification, in which process calcium in the form of calcium carbonate (CaCO₃) trapped by the charcoal is removed by treatment with an inorganic acid and then the charcoal is rinsed with water, dried and activated at a temperature of 500° C. to 1000° C. by contact with steam to stimulate the reaction for the conversion of carbon, in the presence of steam, into carbon monoxide and hydrogen.

The document U.S. Pat. No. 5,064,805 teaches a process for the production of sulphur-poor active charcoal by bringing a coconut shell charcoal into contact with a potassium oxide hydrate.

Furthermore, the document U.S. Pat. No. 4,014,817 teaches a process for the manufacture of active charcoal in which the charcoal is simultaneously shaped and oxidized and then the active charcoal is activated at a temperature of 540° C. to 1100° C. According to this process, prior to the shaping of the charcoal, the latter is washed with acid to remove calcium and magnesium oxides.

None of the abovementioned documents teaches a means for improving PSA gas purification processes, in particular for the purification of hydrogen, that is to say for being able to avoid, minimize or slow down the pollution of the carbonaceous adsorbent by sulphur-comprising impurities, such as mercaptans, H₂S or COS, present in the gas stream, such as hydrogen, to be purified.

The purpose of the present invention is thus to solve this problem so as to obtain an efficient process for the purification of gases comprising at least one gaseous impurity, in particular a sulphur-comprising impurity, chosen from the group formed by mercaptans, H₂S, COS, and the like, in which the gas stream to be purified is brought into contact with particles of a porous carbonaceous adsorbent.

The solution introduced by the present invention is based on an improvement in the active charcoal used in the gas separation process which makes it possible to render this active charcoal less sensitive to the sulphur-comprising entities and compounds found in the gas stream to be separated or to be purified.

The invention consequently relates firstly to a process for the chemical treatment of an active charcoal intended to remove at least a portion of the inorganic oxides liable to be associated with the said charcoal, the said metal oxides being chosen from the group formed by SiO₂, Fe₂O₃, Al₂O₃, Na₂O, CuO and K₂O, in which process the following stages are carried out:

(a) an active charcoal with which inorganic oxides which have to be removed are associated is introduced;

(b) the said active charcoal is washed with at least one solution comprising at least one strong inorganic acid to remove at least a portion of the said oxides;

(c) the said active charcoal washed in stage (b) is rinsed with at least one aqueous solution to remove the residual oxides and/or acid residues;

(d) the active charcoal obtained in stage (c) is dried;

(e) an active charcoal is recovered which has an accessible residual ash level of less than 2% by weight, preferably of less than 1.5% by weight.

Depending upon the situation, the treatment process of the invention can comprise one or more of the following characteristics:

the active charcoal is an earth, vegetable or synthetic charcoal, preferably a vegetable charcoal;

in addition, at least a portion of the calcium and/or magnesium oxides is removed by washing the charcoal in stage (b);

in stage (b), the acid is chosen from the group formed by HCl, HF, HNO₃ and H₂SO₄;

it comprises an additional stage, between stages (b) and (c), of neutralization of the residual acidity by washing with an alkali metal or alkaline earth metal hydroxide solution or a weak acid salt of an alkali metal or alkaline earth metal;

in stage (c), the rinsing is carried out with water, preferably distilled or demineralized water;

in stage (d), the drying is carried out at a temperature of between 40° C. and 120° C., preferably 80° C. and 100° C.

Furthermore, the invention also relates to an improved active charcoal obtained by such a treatment process, the accessible residual ash level of which is less than 2% by weight, preferably less than 1.5% by weight, and to its use in a gas purification process.

The active charcoal according to the invention is characterized by an ash level of less than 2% by weight, preferably of less than 1.5% by weight, and/or by a content of less than 0.1% by weight of each of the metal oxides chosen from the oxides of Fe, Al, Si, Mg, Cu, Na, K and Ca, preferably of less than 0.05% by weight of iron oxide, preferentially of less than 0.03% by weight of iron oxide.

Depending upon the situation, the purification process of the invention can also comprise one or more of the following characteristics:

the active charcoal is chosen from active charcoals produced from coconut shell, peat, lignite, coal, anthracite, polymers or resins;

the gas stream is additionally brought into contact with at least one particulate zeolitic adsorbent; preferably, the contacting of the gas stream with the zeolite particles is carried out subsequent to the contacting of the said gas stream with the particles of porous carbonaceous adsorbent;

the zeolite is of zeolite X or A type or a faujasite exchanged to at least 70% with lithium or with calcium and/or a zeolite of faujasite type with an Si/Al ratio of between approximately 1 and 1.5;

the gas stream is additionally brought into contact with at least one adsorbent formed of particles of activated alumina or of silica gel; preferably, the contacting of the gas stream with the particles of activated alumina or of silica gel is carried out prior to the contacting of the said gas stream, with the particles of mixed or porous carbonaceous adsorbent;

it is of PSA or TSA type and preferably comprises from 2 to 12 adsorbers;

the gas stream is a hydrogen stream, in particular a synthesis gas resulting from a reforming or from a cracking of hydrocarbons;

the adsorption pressure is between 2 bar and 70 bar, preferably between 5 bar and 40 bar;

the desorption pressure is between 0.1 bar and 10 bar, preferably between 1 and 5 bar;

the temperature of the hydrogen stream to be purified is between −25° C. and +60° C., preferably between +5° C. and +35° C.;

the porous carbonaceous adsorbent has pores with a size of between 0.4 nm and 4 nm, preferably between 0.5 nm and 2 nm;

the gas stream is an air or nitrogen stream;

the particle size of the active charcoal particles is between 1 mm and 5 mm;

the sulphur-comprising compound is chosen from H₂S, COS or mercaptans.

In the context of the present invention, the terms “gas purification” are synonymous with the terms “gas separation”.

The invention will now be explained in more detail in the examples below, given by way of illustration but without implied limitation.

### EXAMPLES

The Inventors of the present invention have shown that, surprisingly, significant improvement in the efficiency of a PSA process for the separation or purification of a gas comprising sulphur-comprising impurities, in particular a hydrogen stream, can be obtained by virtue of a judicious chemical treatment of the carbonaceous adsorbent, that is to say of the active charcoal employed in the PSA process.

To do this, experimental trials were carried out on various active charcoals of different natures or origins, which have or have not, depending upon the situation, been subjected to chemical treatments intended to modify their physical or physicochemical characteristics.

The tested charcoals are either charcoals referred to as “earth” charcoals (anthracite, peat, lignite, coke, and the like) or charcoals referred to as “vegetable” charcoals (tree bark, coconut shell, and the like) or charcoals referred to as “synthetic” charcoals (polymers, and the like).

In all cases, the starting active charcoal, that is to say the precursor active charcoal which has not been treated chemically, is a charcoal available commercially from specialist companies, such as Norit, Ceca, Carbotech, Pica, and the like.

The experimental assembly used consists in flushing a sample of 150 cm³ of active charcoal, placed in a cell, with a gas of known composition, namely a gas mixture containing 97.5% of H₂, 2.0% of O₂ and 0.5% of H₂S.

After flushing with this gas mixture at a temperature of 20° C. and at atmospheric pressure for a predetermined time (in this instance 1 hour), the sample is subsequently flushed with a pure hydrogen stream (purity>99.9%) intended to desorb the bulk of the H₂S impurities adsorbed during the initial flushing.

For each of the charcoals thus tested, a sample of fresh product and a sample of product treated with the mixture comprising H₂S, representative of the first third of the charcoal, on the side for introduction of the mixture, were analysed.

The parameter taken into consideration in comparing the active charcoals is the sulphur deposited, that is to say the amount of sulphur present in the treated sample less the amount of sulphur possibly present in the fresh sample.

The results obtained show that:

for most of the active charcoal, whatever their source, sulphur deposition is significant and represents a high fraction, namely several tens of %, of the sulphur introduced in the gas mixture;

conversely, for other charcoals, sulphur deposition is lower than these values by at least one order of magnitude. All the charcoals exhibiting a low sulphur deposition are charcoals which have been subjected to the special washing treatment according to the invention.

An explanation advanced for these results would be that the phenomenon of sulphur deposition is explained by an oxidation reaction, taking into account the fact that a sulphur-comprising compound, such as H₂S, is a reducing entity.

The simplest reaction of this type is:

H₂S+½O₂→H₂O+S

However, it is possible for numerous other reactions to take place simultaneously employing, for example, H₂SO₄, SO₂, and the like.

This reaction can be catalysed by the presence of inorganic oxides, such as Fe₂O₃, Al₂O₃ or SiO₂, at the surface of the active charcoal.

With a washed active charcoal and in particular an active charcoal washed with acid according to the invention, the amount of impurities present in these charcoals can be greatly reduced and, in this way, the kinetics of the reaction for the oxidation of H₂S can be slowed down.

Furthermore, it is possible that the presence of silica (SiO₂) can also promote sulphur deposits and washing with hydrofluoric acid can lead in this way, by removing all or part of the silica, to good results.

Generally, the use of active charcoals which are originally relatively pure is favourable and it can thus be advantageous to use charcoals of vegetable origin rather than earth charcoals.

Activation at approximately 800 to 1 100° C., preferably 900 to 1 000° c., in the absence of oxygen (or with a fluid substantially depleted in oxygen), should also be favourable by suppressing the oxygenated sites which may result in irreversible deposits.

In summary, the impurities present in industrial active charcoals and which originate from the starting material used, that is to say the ground, for earth charcoals, and the plants themselves, for vegetable charcoals, among which impurities may be mentioned, without implied limitation, zinc, iron, silica, alumina, alkali metals, alkaline earth metals, traces of transition elements, and the like, promote sulphur deposits.

The exact mechanisms involved do not form part of the present invention and the chemical relationships mentioned above are given only by way of indication and without the least limitation.

In all cases, the charcoals which comprise few impurities, following a chemical treatment according to the invention, result in an operation, in contact with sulphur-comprising products, without sulphur deposition or with a very substantially reduced deposition, which allows them to be operated over long periods without having to carry out changes in charge.

One of the simplest means for limiting the amount of impurities present is to subject the active charcoal to washing with acid, such as HCl, HF, H₂SO₄, HNO₃ or any strong inorganic acid, optionally to neutralize the residual acidity by washing with an alkaline solution, such as a hydroxide or a weak acid salt of alkali metal or alkaline earth metal, to rinse it with pure water and to dry it.

The washing conditions, such as the nature of the acid, temperature, concentration or time, are to be defined according to the nature of the charcoal and of the acid used.

The level of ashes is perhaps a good means for characterizing these charcoals with few impurities, either after washing or “pure” at the start.

The ashes are the inorganic compounds present in the charcoal. These compounds can originate from contamination, in particular in the case of the charcoals referred to as earth charcoals, or from the natural presence in the organic precursor, for example as trace elements.

As the treatment which results in the active charcoals is essentially oxidizing, the inorganic compounds are found in the form of oxides with a high degree of oxidation: Fe₂O₃, Al₂O₃, SiO₂, CuO, Na₂O, K₂O, and the like.

With the exception of silica SiO₂, all the oxides constituting the ashes are soluble in strong acids to form salts, for example

Fe₂O₃+6HNO₃→3H₂O+2Fe(NO₃)₃

Al₂O₃+6HCl→3H₂O+2AlCl₃

Na₂O+H₂SO₄→H₂O+Na₂SO₄

These salts are soluble, in particular when they are chlorides and nitrates, and washing with acid can largely remove them, in particular followed by a final rinsing with pure water.

A person skilled in the art knows how to bring inorganic acids into contact at temperatures and concentrations where the acid, in particular HNO₃, does not react with the charcoal and results only in the removal of the soluble salts.

In the case where removal of silica is desired, washing with hydrofluoric acid will be employed.

Several acids can optionally be used, as a mixture or by treatment in series.

Preferably, the acid is used in a concentration of 0.05 to 5M, preferably of the order of 0.2 to 2M.

In addition, the active charcoal can be subjected to one or more milling or shaping stages before and/or after the treatment according to the present invention.

The ash level is obtained by removing the charcoal in the form of CO₂. One means consists in heating the charcoal at approximately 1 000° C. in the presence of oxygen until a residue is obtained which is stable by weight.

In the case where the charcoal is not very reactive, a preliminary milling may be employed, indeed even an oxidizing chemical treatment.

The chemical analysis of the ashes can be carried out by dissolving the inorganic oxides in a strong acid (HCl, HNO₃, H₂SO₄, and the like) and chemical analysis of the solution obtained.

A conventional active charcoal comprises between 5 and 15% by weight of ashes. Washing with acid will lower this ash level to a value which can no longer be decreased by subsequent washing. Thus, it may happen that the final ash level of the washed product is not close to 0, provided that the ashes remaining in the final product can no longer be removed by additional acid washing. A person skilled in the art will understand that the ashes which cannot be removed are in practice not accessible to chemical reactants and are thus neutral with respect to the presence of sulphur-comprising compounds. In summary, an active charcoal according to the invention preferably comprises an accessible ash level of less than 2% by weight, which means that, by additional washing with acid under conditions which do not modify the porous structure of the active charcoal, the residual ash level will not fall by more than 2%.

The conditions for washing with the acid will depend on the active charcoal to be treated and on the acid. The measurement of the accessible residual ash level (ARAL) will preferably be carried out under conditions similar to or identical to those of industrial washing. The same concentrations, temperature, type of acid and time will be taken.

The precise measurement of the ARAL of the industrial product will be carried out in the following way:

A sample of the industrial product is oxidized for the measurement of its total ash level (TAL).

A sample of the same product is washed in parallel under physicochemical conditions similar to industrial washing conditions. The washing is carried out so as to remove all accessible ashes. A person skilled in the art will understand that this involves a larger volume of acid and/or a greater number of washing operations and/or a longer washing time than under industrial conditions, which are defined by the cost of the treatment. The difference between the complete washing and the industrial washing is due essentially to the consumption of reactants, to the number of washing operations and to the contact time.

After complete washing, the active charcoal is oxidized for the measurement of the residual ash level (RAL); the equation is:

ARAL=TAL−RAL

ARAL<2% according to the invention

Although it is usual to use active charcoal particles to remove some of the impurities present in hydrogen streams, until now it has never been demonstrated that a porous active charcoal which has been subjected to a specific chemical treatment, as explained above, might have a significant influence on the performance of an adsorption process of PSA type for purifying or separating a gas stream, in particular a gaseous hydrogen stream, comprising sulphur-comprising impurities.

In the light of the results obtained in the laboratory, the process of the invention was validated industrially on a unit which treats a coke oven gas having the following composition:

| | |
|---|---|
| H₂ | 58 mol % |
| CH₄ | 23 mol % |
| CₙHₘ | 3 mol % |
| CO₂ | 3 mol % |
| CO | 6 mol % |
| N₂ | 6 mol % |
| O₂ | 1 mol % |

and comprising in particular, as other impurities, water and several tens of to several hundred ppm of H₂S.

In contrast to the experience acquired with a conventional activated charcoal, which required, as was indicated above, several changes in charge per year, the unit in question, comprising a first bed of specially treated activated charcoal, operated satisfactorily for several years without the charge in question having to be changed.

Such a process thus introduces very significant advantages with respect to the solution consisting in using conventional charcoals.

It eliminates any non-productive time, and the corresponding losses in H₂ production, required for the discharging of contaminated charges and for the insertion of a fresh charge.

The initial additional expenditure of several tens of percentage points due to the additional treatments which have to be carried out is immediately compensated for by the fact that the charge does not have to be replaced after a few months.

Methods had been introduced to limit the abovementioned disadvantages but they also resulted in significant capital costs.

Thus, the PSA units in question comprised a backup adsorber so as to be able to act cyclicly on each adsorber without having to shut down the hydrogen production.

In addition to the capital cost of an additional adsorber, this solution had required the provision of expensive isolation means on each of the adsorbers in order to be able to operate in complete safety on an in-service unit.

In the same way, to limit the replacement cost of the activated charcoal, the contaminated charcoal was reprocessed in order that it might be reused. In addition to the treatment cost, it was necessary to add 15 to 30% of fresh charcoal in order to compensate for losses and the charcoal thus obtained had lower adsorption capacities than the original charcoal, thus resulting in a drop in performance.

It thus appears that, while the use of conventional charcoals makes it possible to produce pure hydrogen, there is an indisputable advantage in using the active charcoal treated according to the present invention.

In the context of the present invention, commercially available active charcoals, namely active charcoals prepared from peat, coke, anthracite, coal, tree bark, fruit kernels or plant husks, for example coconut shells, almond shells, and the like can be used as precursors.

The activated charcoal is treated chemically, as explained above, in order to remove the oxides therefrom, optionally brought to the appropriate dimensions, before or after washing with acid, optionally milled and then extruded in the presence of a binder with a carbonaceous base, for example pitch.

The invention is not limited to the purification of hydrogen but it also applies to the purification of other gases, in particular air, nitrogen, CO, CH₄ and CO₂, provided that the gas mixture comprises sulphur-comprising impurities.

1. Process for the chemical treatment of an active charcoal intended to remove at least a portion of the inorganic oxides liable to be associated with the said charcoal, the said metal oxides being chosen from the group formed by SiO₂, Fe₂O₃, Al₂O₃, Na₂O, CuO and K₂O, in which process the following stages are carried out:
(a) an active charcoal with which inorganic oxides which have to be removed are associated is introduced;
(b) the said active charcoal is washed with at least one solution comprising at least one strong inorganic acid to remove at least a portion of the said oxides;
(c) the said active charcoal washed in stage (b) is rinsed with at least one aqueous solution to remove the residual oxides and/or acid residues;
(d) the active charcoal obtained in stage (c) is dried;
(e) an active charcoal is recovered which has an accessible residual ash level of less than 2% by weight, preferably of less than 1.5% by weight.

2. Process according to claim 1, characterized in that the active charcoal is an earth, vegetable or synthetic charcoal, preferably a vegetable charcoal.

3. Process according to claim 1 or 2, characterized in that, in addition, at least a portion of the calcium and/or magnesium oxides is removed by washing the charcoal in stage (b).

4. Process according to claims 1 to 3, characterized in that, in stage (b), the acid is chosen from the group formed by HCl, HF, HNO₃ and H₂SO₄.

5. Process according to claims 1 to 4, characterized in that it comprises an additional stage, between stages (b) and (c), of neutralization of the residual acidity by washing with an alkali metal or alkaline earth metal hydroxide solution or a weak acid salt of an alkali metal or alkaline earth metal.

6. Process according to claims 1 to 5, characterized in that, in stage (c), the rinsing is carried out with water, preferably distilled or demineralized water.

7. Process according to claims 1 to 6, characterized in that, in stage (d), the drying is carried out at a temperature of between 40° C. and 120° C., preferably 80° C. and 100° C.

8. Active charcoal capable of being obtained by a chemical treatment process according to one of claims 1 to 7, the accessible residual ash level of which is less than 2% by weight, preferably less than 1.5% by weight.

9. Active charcoal which is characterized by an ash level of less than 2% by weight, preferably of less than 1.5% by weight, and/or by a content of less than 0.1% by weight of each of the metal oxides chosen from the oxides of Fe, Al, Si, Mg, Cu, Na, K and Ca, preferably of less than 0.05% by weight of iron oxide, preferentially of less than 0.03% by weight of iron oxide.

10. Process for the purification of a gas stream comprising at least one sulphur-comprising compound, in which process the gas stream to be purified is brought successively into contact with an active charcoal according to either of claims 8 and 9 and/or an active charcoal obtained by a chemical treatment process according to one of claims 1 to 7.

11. Process according to claim 10, characterized in that the gas stream is additionally brought into contact with at least one particulate zeolitic adsorbent.

12. Process according to claim 11, characterized in that the zeolite is of zeolite X or A type or a faujasite exchanged to at least 70% with lithium or with calcium and/or a zeolite of faujasite type with an Si/Al ratio of between approximately 1 and 1.5, preferably 1 to 1.25.

13. Process according to one of claims 10 to 12, characterized in that the gas stream is additionally brought into contact with at least one adsorbent formed of particles of activated alumina or of silica gel.

14. Process according to one of claims 10 to 13, characterized in that it is of PSA or TSA type and preferably comprises from 2 to 12 adsorbers.

15. Process according to one of claims 10 to 14, characterized in that the gas stream is a hydrogen stream, in particular a synthesis gas resulting from a reforming or from a cracking of hydrocarbons.

16. Process according to one of claims 10 to 14, characterized in that the gas stream is an air or nitrogen stream.

17. Process according to one of claims 10 to 16, characterized in that the particle size of the active charcoal particles is between 1 mm and 5 mm.

18. Process according to one of claims 10 to 17, characterized in that the sulphur-comprising compound is chosen from H₂S, COS or mercaptans.
